(19) United States
(12) Patent Application Publication
(10) Pub. No.: US 2013/0021315 A1
(43) Pub. Date: Jan. 24, 2013

(54) LCD DEVICE AND SIGNAL DRIVING METHOD THEREOF

(71) Applicant: Chihtsung Kang, Shenzhen (CN)

(72) Inventor: Chihtsung Kang, Shenzhen (CN)

(73) Assignee: SHENZHEN CHINA STAR OPTOELECTRONICS TECHNOLOGY CO., LTD., Shenzhen (CN)

(21) Appl. No.: 13/375,474

(22) PCT Filed: Aug. 25, 2011
(86) PCT No.: PCT/CN2011/078954

§ 371 Date: Nov. 30, 2011

(30) Foreign Application Priority Data
Jul. 20, 2011 (CN) 201110203323.7

(51) Int. Cl. G09G 3/36; G06F 3/038

(52) U.S. Cl. 345/212; 345/92

(57) ABSTRACT

The present invention discloses an LCD device. The LCD device employs pre-charging within a frame accompanying high and low levels signal of array common lines. Each pixel is charged a high voltage before writing into a correct data signal, that is, the over driving is performed before the correct data signal is written into the pixel. The present invention also discloses a signal driving method for the LCD device. Compared with the prior art, the frame buffer is not required in the present invention on one hand; the over driving can be performed without complex timing functions on another hand; and the incorrect twist angles of the liquid crystals which are driven instantaneously can be significantly avoided when using the conventional over driving by a look-up table for comparing two sequential image signals.

### FIELD OF THE INVENTION

The present invention relates to a display device, and especially to a liquid crystal display (LCD) device. The present invention further relates to a signal driving method, and especially to a signal driving method for an LCD device.

### BACKGROUND OF THE INVENTION

Over driving is a technology used for improving a display effect of an LCD panel. Conventional over-driving technology generally utilizes a look-up table to find a predetermined interpolated voltage values by means of comparing two sequential image signals for increasing response speed. This technology requires using a frame buffer for storing a previous image and then comparing the previous image to a current image. Said predetermined interpolated voltage values are also required to be stored in a storage device; in addition, a time control register (TCON) is also required to cooperate thereof with the above-mentioned.

The over driving that is realized in a row driving is shown in FIG. 1, in which a common electrode voltage of common lines is set as 5V, and an original signal is switched from 1V (voltages of positive and negative polarities are respectively 6V and 4V) to 3V (voltages of the positive and negative polarities are respectively 8V and 2V). In order to increase the response speed, a signal 5V (voltages of the positive and negative polarities are respectively 10V and 0V) is generally inserted into the original signal. When a voltage in a pixel is changed from 1V to 3V, there is a frame time required to charge the pixel to get the 5V voltage.

In view of a patterned vertical alignment (PVA) panel, if only a look-up table of interpolation is applied, a waveform that a low grayscale is switched to a high grayscale has a shape like a rhino horn which decreases the display effect. In order to achieve high penetration, a designed pitch of strip electrode in a pixel electrode is quite large, resulting in incorrect twist angles of liquid crystals which are driven instantaneously.

Therefore, there is a significant need to provide an LCD device and a signal driving method thereof for solving the problem existing in the prior art.

### SUMMARY OF THE INVENTION

An objective of the present invention is to provide an LCD device, which can overcome the drawbacks that the over driving can not be realized in a frame time, and the frame buffer for storing is required, and the display effect is poor in the prior art.

To achieve the foregoing objective, an LCD device which is constructed in the present invention includes: a scan driver module for generating scanning signals and transmitting the scanning signals to the scan lines; a data driver module for generating data signals and transmitting the data signals to the data lines; a TFT array panel having a plurality of pixels, each pixel comprising a sub pixel R, a sub pixel G, and a sub pixel B; a plurality of scan lines coupled to the sub pixels of the pixels, wherein the scanning signals sequentially scan row by row in a longitudinal direction with all the sub pixels; a plurality of data lines, each data line coupled to at least one of the sub pixels of the pixels, wherein the data lines are utilized to pre-charge the sub pixels before inputting the data signals into the sub pixels; a plurality of common lines, the common lines coupled to the sub pixels of the pixels for applying a high voltage or a low voltage to the sub pixels according to polarities of the sub pixels coupled thereto; wherein the sub pixels having a same polarity are arranged in a same row, the common lines are coupled to the sub pixels having the same polarity, the data signals are utilized to be pre-charged into the sub pixels according to the polarities of the sub pixels, the scanning signal are utilized to turn on gates of the sub pixels for making the data signals to be pre-charged into the sub pixels before the data signals are written into the sub pixels, the three sub pixels of the pixel have the same polarity and are parallel arranged to a scanning direction of the scanning signals, and two adjacent rows of the sub pixels have two opposite polarities.

In the LCD device of the present invention, the scanning signals are utilized to turn off the gates of the sub pixels in a time period starting from the data signals being pre-charged into the sub pixels to the data signals being written into the sub pixels.

In the LCD device of the present invention, when the scanning signals turn off the sub pixels, the scanning signals turn on the gates of one next row of the sub pixels, and the data signals are pre-charged into the one next row of the sub pixels.

Another objective of the present invention is to provide an LCD device, which can overcome the drawbacks that the over driving can not be realized in a frame time, and the frame buffer for storing is required, and the display effect is poor in the prior art.

To achieve the foregoing objective, an LCD device which is constructed in the present invention includes: a scan driver module for generating scanning signals and transmitting the scanning signals to the scan lines; a data driver module for generating data signals and transmitting the data signals to the data lines; a TFT array panel having a plurality of pixels, each pixel comprising a sub pixel R, a sub pixel G, and a sub pixel B; a plurality of scan lines coupled to the sub pixels of the pixels, wherein the scanning signals sequentially scan row by row in a longitudinal direction with all the sub pixels; a plurality of data lines, each data line coupled to at least one of the sub pixels of the pixels, wherein the data lines are utilized to pre-charge the sub pixels before inputting the data signals into the sub pixels; a plurality of common lines, the common lines coupled to the sub pixels of the pixels for applying a high voltage or a low voltage to the sub pixels according to polarities of the sub pixels coupled thereto; wherein the sub pixels having a same polarity are arranged in a same row, the common lines are coupled to the sub pixels having the same polarity, and wherein the data signals are utilized to be pre-charged into the sub pixels according to the polarities of the sub pixels.

In the LCD device of the present invention, the scanning signal are utilized to turn on gates of the sub pixels for making the data signals to be pre-charged into the sub pixels before data signals are written into the sub pixels.

In the above-mentioned LCD device, the scanning signals are utilized to turn off the gates of the sub pixels in a time period starting from the data signals being pre-charged into the sub pixels to the data signals being written into the sub pixels.

In the above-mentioned LCD device, when the scanning signals turn off the sub pixels, the scanning signals turn on the gates of one next row of the sub pixels, and the data signals are pre-charged into the one next row of the sub pixels.

In the LCD device of the present invention, the three sub pixels of the pixel have the same polarity and are parallel arranged to a scanning direction of the scanning signals.

In the LCD device of the present invention, two adjacent rows of the sub pixels have two opposite polarities.

Another objective of the present invention is to provide a signal driving method for an LCD device.

To achieve the foregoing objective, a signal driving method for an LCD device is constructed in the present invention. The LCD device includes a scan driver module, a data driver module, a TFT array panel, a plurality scan lines and data lines. The TFT array panel has a plurality of pixels, each pixel comprising a sub pixel R, a sub pixel G, and a sub pixel B, wherein the sub pixels having a same polarity being arranged in a same row, the common lines are coupled to the sub pixels having the same polarity. The method includes the steps of: (A) generating scanning signals and transmitting the scanning signals from the scan driver module to the scan lines; (B) generating data signals and transmitting the data signals from the data driver module to the data lines; (C) coupling the scanning signals to the sub pixels of the pixel via the scan lines, wherein the scanning signals sequentially scan row by row in a longitudinal direction with all the sub pixels; (D) transmitting the data signals to at least one of the sub pixels of the pixels via the data lines, wherein the data lines pre-charge the sub pixels before inputting the data signals into the sub pixels; (E) applying a high voltage or a low voltage to the sub pixels via the common lines according to polarities of the sub pixels coupled thereto; (F) pre-charging the sub pixels in the data signals according to the polarities of the sub pixels.

In the signal driving method for the LCD device of the present invention, the method further includes a step of: (G) turning on gates of the sub pixels by the scanning signal for making the data signals to be pre-charged into the sub pixels before data signals are written into the sub pixels.

In the above-mentioned signal driving method for the LCD device, the method further includes a step of: (H) turning off the gates of the sub pixels by the scanning signals in a time period starting from the data signals being pre-charged into the sub pixels to the data signals being written into the sub pixels.

In the above-mentioned signal driving method for the LCD device, the method further includes a step of: (I) turning on the gates of one next row of the sub pixels by the scanning signals and being pre-charged into the one next row of the sub pixels in the data signals when the scanning signals turn off the sub pixels.

The advantageous effects of the present invention lie in: first, the frame buffer is not required in the present invention as compared to the prior art; second, the over driving can be performed without complex timing functions; moreover, the incorrect twist angles of the liquid crystals which are driven instantaneously can be significantly avoided when using the conventional over driving by the look-up table for comparing two sequential image signals.

It is to be understood that both the foregoing general description and the following detailed description of the present invention are exemplary and explanatory and are intended to provide further explanation of the invention as claimed.

### DESCRIPTION OF THE DRAWINGS

FIG. 1 is a schematic drawing illustrating a row driving of an over driving in the prior art;

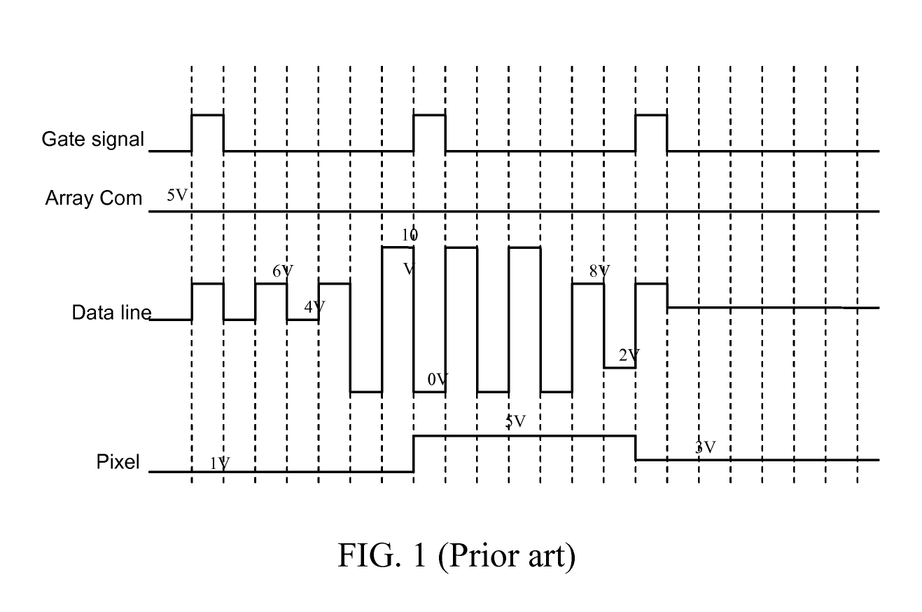

FIG. 2 is a block diagram illustrating an LCD panel of the present invention;

FIG. 3 is a partial schematic drawing illustrating the LCD device according to a first preferred embodiment of the present invention; and

FIG. 4 is a schematic drawing illustrating a signal driving of the LCD device according to a first preferred embodiment of the present invention.

### DETAILED DESCRIPTION OF THE PREFERRED EMBODIMENTS

Descriptions of the following embodiments refer to attached drawings which are utilized to exemplify specific embodiments. Directional terms mentioned in the present invention, such as “top” and “down”, “front”, “rear”, “left”, “right”, “inside”, “outside”, “side” and so on are only directions with respect to the attached drawings. Therefore, the used directional terms are utilized to explain and understand the present invention but not to limit the present invention.

In different drawings, the same reference numerals refer to like parts throughout the drawings.

The LCD device of the present invention employs pre-charging within a frame accompanying high and low levels signals of an array common (Array Com) lines. Each pixel is charged a high voltage before writing into a correct data signal, that is, the over driving is performed before the correct data signal is written into the pixel.

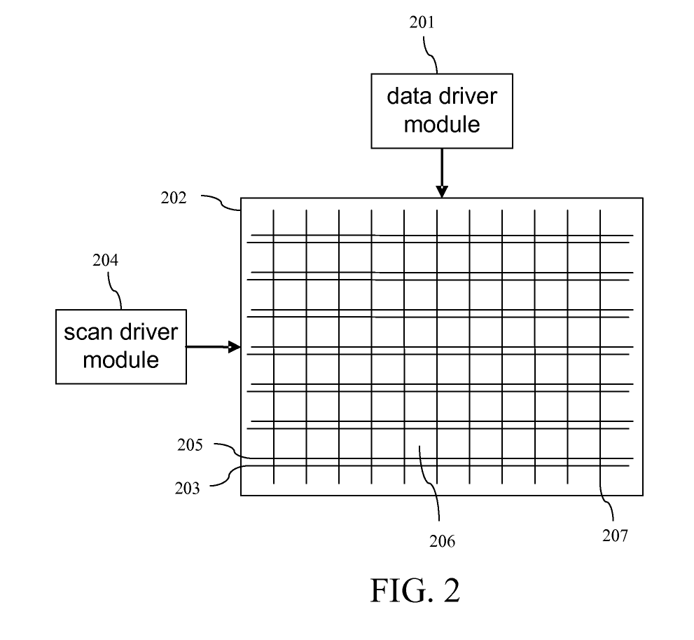

Referring to FIG. 2, FIG. 2 is a block diagram illustrating an LCD panel of the present invention. The LCD device of the present invention includes a scan driver module 204, a data driver module 201, a Thin Film Transistor (TFT) array panel 202, common lines 205, scan lines (gate lines) 203 and data lines 207, where the scan lines 203 are disposed perpendicular to the data lines 207. The TFT array panel 202 has a plurality of pixels 206, and each pixel 206 includes three sub pixels that are not shown in FIG. 2. The scan driver module 204 is utilized to generate scanning signals, and the scanning signals are transmitted to the scan lines 203 by the scan driver module 204. The data driver module 201 is utilized to generate data signals, and the data signals are transmitted to the data lines 207 by the data driver module 201. The scan lines 203 are coupled to the pixels 206. Specifically, the scan lines 203 are coupled to the pixels 206, and the data lines 207 are coupled to the pixels 206. Specifically, the data line 207 is coupled to at least a sub pixel of the pixel 206, and the common lines 205 are coupled to the pixels 206. Specifically, the common line 205 is coupled to at least a sub pixel of the pixel 206.

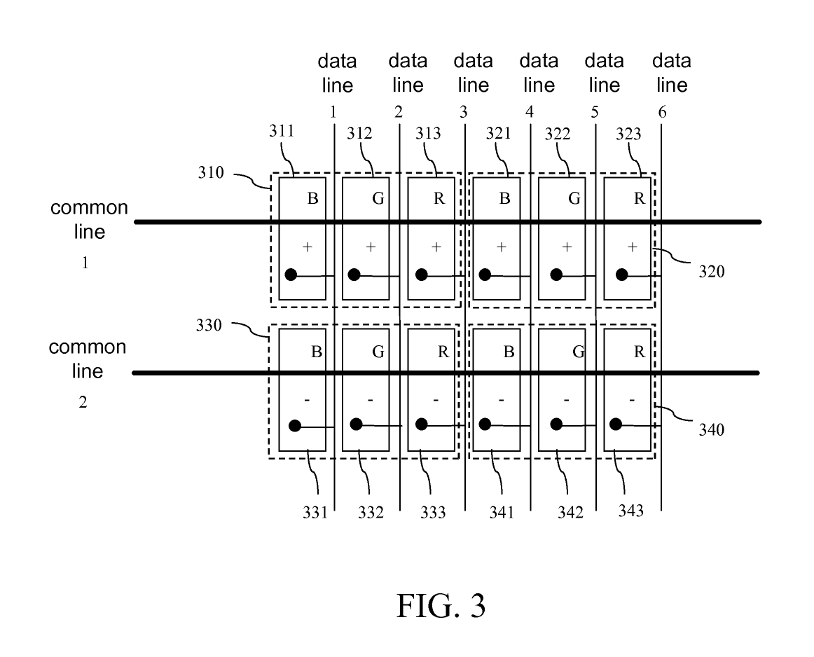

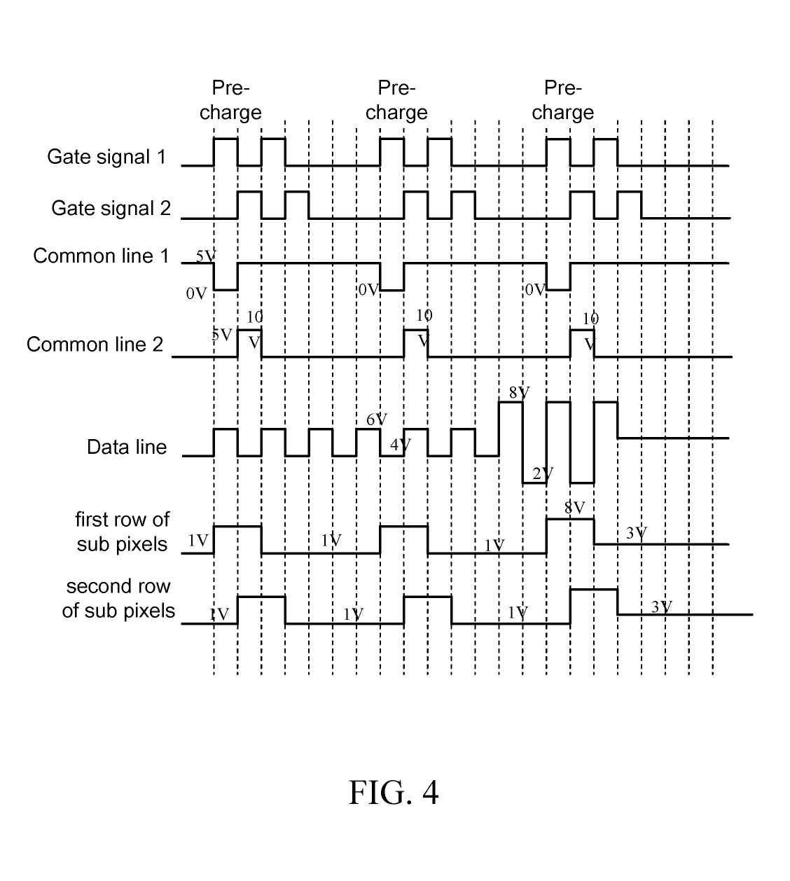

Referring to FIG. 3 and FIG. 4, FIG. 3 is a partial schematic drawing illustrating the LCD device according to a first preferred embodiment of the present invention, and FIG. 4 is a schematic drawing illustrating a signal driving of the LCD device according to a first preferred embodiment of the present invention. In the embodiment, the pixel consists of three sub pixels (a sub pixel R, a sub pixel G, and a sub pixel B). In the LCD device of the present invention, the scanning signals of the scan lines sequentially scan row by row in a longitudinal direction with all of the sub pixels. The sub pixel R, the sub pixel G, and the sub pixel B are parallel arranged to a scanning direction of the scanning signals. The data lines (including data line 1, data line 2, data line 3, data line 4, data line 5, and data line 6) are arranged perpendicular to the common lines. In the embodiment, the sub pixels located on the same row in the TFT array panel all have a same polarity, that is, the three sub pixels in each pixel all have the same polarity. Two adjacent rows of the sub pixels have two opposite polarities. The data lines (including data line 1, data line 2, data line 3, data line 4, data line 5, and data line 6) are coupled to the sub pixels located on the same row. Specifically, the data line 1 is coupled to a sub pixel B311 of a first pixel 310 having a positive polarity and to a sub pixel B331 of a third pixel 330 having a negative polarity, and the data line 2 is coupled to a sub pixel G312 of a first pixel 310 having a positive polarity and to a sub pixel G332 of a third pixel 330 having a negative polarity. The common lines (including a common line 1 and a common line 2) are disposed parallel to the scanning direction of the scanning signals, and the common lines are arranged in an array. The first row of the sub pixels consist of the sub pixel B311, the sub pixel G312, and the sub pixel R313 of the first pixel 310 as well as the sub pixel B321, the sub pixel G322, and the sub pixel R323 of the second pixel 320. The second row of the sub pixels consist of the sub pixel B331, the sub pixel G332, and the sub pixel R333 of the third pixel 330 as well as the sub pixel B341, the sub pixel G342, and the sub pixel R343 of the fourth pixel 340. The common line is coupled to the sub pixels in the same row, that is, the common line is coupled to the sub pixels having the same polarity. Specifically, the common line 1 (com 1) is coupled to the sub pixel R311, the sub pixel G312, and the sub pixel B313 of the first pixel 310 having the positive polarity as well as the sub pixel R321, the sub pixel G322, and the sub pixel B323 of the second pixel 320 having the positive polarity. the common line 2 (com 2) is coupled to the sub pixel R331, the sub pixel G332, and the sub pixel B333 of the third pixel 330 as well as the sub pixel R341, the sub pixel G342, and the sub pixel B343 of the fourth pixel 340. As shown in FIG. 4, the LCD device of the present invention does not need to spend one frame time to charge the pixel because the voltage of the pixel has been charged by the data signal in the same frame before the voltage of the pixel becomes 3V. Specifically, before the gate line transmits a gate signal (scanning signal) for a correct data signal being written into the first row of the sub pixels, the gate line transmits a gate signal to the first row of the sub pixels in advance so as to turn on the gates of the first row of the sub pixels for the data line pre-charging the first row of the sub pixels. Then the gates of the first row of the sub pixels are turned off under the control of the gate signal from the scan line, and then the gate line transmits a gate signal to the first row of the sub pixels for turn on the gates of the first row of the sub pixels; meanwhile, the correct data signal is written into the first row of the sub pixels. The same row of the sub pixels has the same polarity, and the common line is coupled to the sub pixels having the same polarity. Thus, the sub pixel B311, the sub pixel G312, and sub pixel R313 of the first pixel 310 as well as the sub pixel B321, the sub pixel G322, and the sub pixel R323 of the second pixel 320, all of which are coupled to the common line 1 in the row of the sub pixels are all positive. They are charged in a high voltage with respect to a low level 0V of the common line 1. When the gates of the first row of sub pixels are turned off, a second gate line transmits a gate signal to the second row of the sub pixels at the same time for pre-charging the second row of the sub pixels. It should be noted that the data signals are utilized to be pre-charged into the sub pixels according to the polarities of the sub pixels in the embodiment. Similarly, before the voltages of the second row of the sub pixels become 3V from 1V, the data signal on the data line are utilize to pre-charge the second row of the sub pixels. Specifically, the gate line transmits a high level signal to the gate of the second of the sub pixels for turning on the gate of the second of sub pixels. Specifically, before the gate line transmits a gate signal for a correct data being written into the second row of the sub pixels, the gate line transmits a gate signal to the second row of the sub pixels in advance so as to turn on the gates of the second row of the sub pixels for the data signal of the data line pre-charging the second row of the sub pixels. Then the gates of the first row of the sub pixels are turned off, and then the gate line transmits a gate signal to the second row of the sub pixels for turn on the gates of the second row of the sub pixels; meanwhile, the correct data signal is written into the second row of the sub pixels. The polarities of the second row of the sub pixels are the same to the polarities of the data signals. The sub pixels in the second row, which are coupled to the common line 2, have the sub pixel R331, the sub pixel G332, and the sub pixel B333 of the third pixel 330 as well as the sub pixel R341, the sub pixel G342, and the sub pixel B343 of the fourth pixel 340. The polarities of the second row of the sub pixels are negative, the second row of the sub pixels are charged a high voltage by the common line 2 with a high level 10V. When the gates of the second row of sub pixels are turned off, a third gate line transmits a gate signal to the third row of the sub pixels at the same time for turning on the gates of the third row of sub pixels. The rest may be deduced by analogy, and the over driving can be realized in a frame time. In the embodiment, the common line 1 and 2 transmit the high or low level according to the polarities of the sub pixels.

In summary, the signal driving method for the LCD device of the present invention comprises the steps of: generating scanning signals and transmitting the scanning signals from the scan driver module 204 to the scan lines 203; generating data signals and transmitting the data signals from the data driver module 201 to the data lines 207;transmitting the scanning signals to the coupled sub pixels of the pixel 206 via the scan lines 203, in which the scanning signals sequentially scan row by row in the longitudinal direction with all the sub pixels; transmitting the data signals to at least one of the sub pixels of the pixels 206 via the data lines 207, in which the data lines 207 pre-charge the sub pixels before inputting the data signals into the sub pixels; applying a high voltage or a low voltage to the sub pixels via the common lines 205 according to polarities of the sub pixels coupled thereto. pre-charging the sub pixels in the data signals according to the polarities of the sub pixels; turning on gates of the sub pixels by the scanning signal for making the data signals be pre-charged into the sub pixels before the correct data signals being written into the sub pixels; turning off the gates of the sub pixels by the scanning signals in a time period starting from the data signals being pre-charged into the sub pixels to the correct data signals being written into the sub pixels; turning on the gates of one next row of the sub pixels by the scanning signals and being pre-charged into the one next row of the sub pixels in the data signals when the scanning signals turn off the sub pixels.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

1. An LCD device, comprising:
a scan driver module for generating scanning signals;
a data driver module for generating data signals;
a TFT array panel having a plurality of pixels, each pixel comprising a sub pixel R, a sub pixel G, and a sub pixel B;
a plurality of scan lines coupled to the sub pixels of the pixels, wherein the scanning signals sequentially scan row by row in a longitudinal direction with all the sub pixels, and wherein the scanning driving module transmits the scanning signals to the scan lines;
a plurality of data lines, each data line coupled to at least one of the sub pixels of the pixels, wherein the data lines are utilized to pre-charge the sub pixels before inputting the data signals into the sub pixels, and wherein the data driving module transmits the data signals to the data lines;
a plurality of common lines coupled to the sub pixels of the pixels, for applying a high voltage or a low voltage to the sub pixels according to polarities of the sub pixels coupled thereto;
wherein the sub pixels having a same polarity are arranged in a same row, the common lines are coupled to the sub pixels having the same polarity, the data signals are utilized to be pre-charged into the sub pixels according to the polarities of the sub pixels, the scanning signal are utilized to turn on gates of the sub pixels for making the data signals to be pre-charged into the sub pixels before the data signals are written into the sub pixels, the three sub pixels of the pixel have the same polarity and are parallel arranged to a scanning direction of the scanning signals, and two adjacent rows of the sub pixels have two opposite polarities.

2. The LCD device according to claim 1, wherein the scanning signals are utilized to turn off the gates of the sub pixels in a time period from the data signals being pre-charged into the sub pixels to the data signals being written into the sub pixels.

3. The LCD device according to claim 1, wherein when the scanning signals turn off the sub pixels, the scanning signals turn on the gates of one next row of the sub pixels, and the data signals are pre-charged into the one next row of the sub pixels.

4. An LCD device, comprising:
a scan driver module for generating scanning signals;
a data driver module for generating data signals;
a TFT array panel having a plurality of pixels, each pixel comprising a sub pixel R, a sub pixel G, and a sub pixel B;
a plurality of scan lines, the scan lines coupled to the sub pixels of the pixels, wherein the scanning signals sequentially scan row by row in a longitudinal direction with all the sub pixels, and wherein the scanning driving module transmits the scanning signals to the scan lines;
a plurality of data lines, each data line coupled to at least one of the sub pixels of the pixels, wherein the data lines are utilized to pre-charge the sub pixels before inputting the data signals into the sub pixels, and wherein the data driving module transmits the data signals to the data lines;
a plurality of common lines, the common lines coupled to the sub pixels of the pixels for applying a high voltage or a low voltage to the sub pixels according to polarities of the sub pixels coupled thereto;
wherein the sub pixels having a same polarity are arranged in a same row, the common lines are coupled to the sub pixels having the same polarity, and wherein the data signals are utilized to be pre-charged into the sub pixels according to the polarities of the sub pixels.

5. The LCD device according to claim 4, wherein the scanning signal are utilized to turn on gates of the sub pixels for making the data signals to be pre-charged into the sub pixels before data signals are written into the sub pixels.

6. The LCD device according to claim 5, wherein the scanning signals are utilized to turn off the gates of the sub pixels in a time period starting from the data signals being pre-charged into the sub pixels to the data signals being written into the sub pixels.

7. The LCD device according to claim 6, wherein when the scanning signals turn off the sub pixels, the scanning signals turn on the gates of one next row of the sub pixels, and the data signals are pre-charged into the one next row of the sub pixels.

8. The LCD device according to claim 4, wherein the three sub pixels of the pixel have the same polarity and are parallel arranged to a scanning direction of the scanning signals.

9. The LCD device according to claim 4, wherein two adjacent rows of the sub pixels have two opposite polarities.

10. A signal driving method for an LCD device, the LCD device comprising a scan driver module, a data driver module, a TFT array panel, a plurality scan lines and data lines, the TFT array panel having a plurality of pixels, each pixel comprising a sub pixel R, a sub pixel G, and a sub pixel B, wherein the sub pixels having a same polarity are arranged in a same row, the common lines are coupled to the sub pixels having the same polarity, the method comprising the steps of:
(A) generating scanning signals and transmitting the scanning signals from the scan driver module to the scan lines;
(B) generating data signals and transmitting the data signals from the data driver module to the data lines;
(C) coupling the scanning signals to the sub pixels of the pixel via the scan lines, wherein the scanning signals sequentially scan row by row in a longitudinal direction with all the sub pixels;
(D) transmitting the data signals to at least one of the sub pixels of the pixels via the data lines, wherein the data lines pre-charge the sub pixels before inputting the data signals into the sub pixels;
(E) applying a high voltage or a low voltage to the sub pixels via the common lines according to polarities of the sub pixels coupled thereto;
(F) pre-charging the sub pixels in the data signals according to the polarities of the sub pixels.

11. The signal driving method for an LCD device according to claim 10, further comprising:
(G) turning on gates of the sub pixels by the scanning signal for making the data signals be pre-charged into the sub pixels before data signals are written into the sub pixels.

12. The signal driving method for an LCD device according to claim 11, further comprising:
(H) turning off the gates of the sub pixels by the scanning signals in a time period starting from the data signals being pre-charged into the sub pixels to the data signals being written into the sub pixels.

13. The signal driving method for an LCD device according to claim 12, further comprising:
(I) turning on the gates of one next row of the sub pixels by the scanning signals and being pre-charged into the one next row of the sub pixels in the data signals when the scanning signals turn off the sub pixels.
